(19) United States
(12) Patent Application Publication
(10) Pub. No.: US 2009/0211677 A1
(43) Pub. Date: Aug. 27, 2009

(54) MODULAR TIRE ASSEMBLY

(76) Inventors: Richard L. Palinkas, Northfield, CT (US); Ian Laskowitz, Woodbury, CT (US); George H. Nybakken, Middlebury, CT (US)

Correspondence Address: PATENT ADMINISTRATOR;CHEMTURA CORPORATION, 199 Benson Road, Middlebury, CT, 06749, US

(21) Appl. No.: 12/036,951

(22) Filed: Feb. 25, 2008

(51) Int. Cl. B60C 7/00; B60C 11/00; B60C 25/01

(52) U.S. Cl. 152/209.1; 152/302; 157/1.1

(57) ABSTRACT

The present invention is generally related to a tire assembly comprising a plurality of non-pneumatic tires removably disposed on a single rim.

### BACKGROUND OF THE INVENTION

1. Field of the Invention

The present invention relates to a modular tire assembly. In particular, the invention relates to a tire assembly of non-pneumatic tires removably disposed on a single rim, which, for example, is suitable for off-the-road vehicles.

2. Discussion of Background Information

Off-the-road (OTR) vehicles, also known as off-highway vehicles, are commonly used in rugged terrain for mining, excavation, construction, military applications, and other heavy industrial applications. OTR vehicles include tractors, trucks, loaders, dozers, graters, excavators, etc., and may have operational weights as high as 380 to 460 tons. Typically such OTR vehicles have several inflatable tires made of rubber. These applications require that each tire have properties such as being puncture-proof, able to carry relatively heavy loads, and good resistance to wear and tear. Conventional inflatable tires generally have short operational life spans of about six months. Further, the typical rugged operating environment for OTR vehicles exposes the tires to possible failures, such as punctures, blowouts, tears, and separation of the tire from the rim. Thus, the time and cost to maintain such OTR vehicles increases because the inflatable tires need to be replaced due to normal wear and tire failure. For mining vehicles, for example, shortages of suitable replacement tires may cause a mine operator to shut down production while waiting for new replacement tires. This may cause particular hardships for remotely located mines that receive sporadic or irregular shipments of new supplies.

In addition, when a conventional pneumatic tire fails on a vehicle, the vehicle is typically inoperable until the tire is replaced. For smaller vehicles, such as passenger vehicles, spare tires may serve as a temporary alternative until the damaged tire is repaired or replaced. For larger vehicles, such as typical OTR vehicles, spare tires are impractical. Instead, a maintenance vehicle may be dispatched to the inoperable vehicle and aid in hoisting the vehicle and replacing the damaged tire. Alternatively, the vehicle may be towed to a maintenance facility where the damaged tire is repaired or replaced. Both options undesirably require significant vehicle down time.

The need exists for tires, particularly tires suitable for OTR vehicles, that are more durable than conventional pneumatic tires. The need also exists for processes for quickly and easily repairing OTR vehicles having damaged tires and minimizing vehicle down time.

### SUMMARY OF THE INVENTION

In a first aspect of the present invention, there is provided a tire assembly comprising a plurality of non-pneumatic tires removably disposed on a single rim. In one embodiment, each of the plurality of non-pneumatic tires is mounted to a respective one of a plurality of bands. Each of the plurality bands may be removably mounted to the rim.

In a second aspect of the present invention, there is provided a tire assembly comprising a central disc, a plurality of bands removably mounted to the single central disc, and a plurality of non-pneumatic tires, each of the plurality of non-pneumatic tires being mounted to a respective one of the plurality of bands. In one embodiment, each of the plurality of non-pneumatic tires are molded onto a respective one of the plurality of bands. In one embodiment, each of the plurality of non-pneumatic tires are affixed to a respective one of the plurality of bands with an adhesive.

In a third aspect of the present invention, there is provided a process for repairing a tire assembly comprising (a) removing at least one of a plurality of non-pneumatic tires disposed on a single rim and (b) replacing the at least one of a plurality of removed non-pneumatic tires with at least one replacement non-pneumatic tire on the rim.

In a fourth aspect of the present invention, there is provided a process for forming a tire assembly, comprising removably mounting a first non-pneumatic tire to a rim; and removably mounting a second non-pneumatic tire to the rim.

In some embodiments of the present invention there may be provided one or more gaps which separate each of the plurality of the non-pneumatic tires. Optionally, the gap may be zero such that each of the tires abuts any adjoining tires. In some embodiments, each of the plurality of non-pneumatic tires has a substantially similar shape and dimension. Optionally, each of the plurality of non-pneumatic tires may have a different sidewall configuration and/or different tread pattern, including a slick tread. In some embodiments, the number of tires removably mounted to a single rim may range from 2 to 10 tires. In some embodiments, at least one rim of an off-the-road vehicle comprises a tire assembly according to the aspects and embodiments of the present invention.

### BRIEF DESCRIPTION OF THE DRAWINGS

The foregoing and other objects and advantages of the present invention will appear more fully from the following description, made in connection with the accompanying drawings of non-limiting embodiments of the inventions, wherein like characters refer to the same or similar parts throughout the views, and in which:

FIG. 1 is a perspective view of a tire assembly constructed in accordance with an embodiment of the present invention;

FIG. 2A is a perspective view of a tire assembly having a band for each tire constructed in accordance with an embodiment of the present invention;

FIG. 2B is a cross sectional view of the tire assembly on a rim;

FIG. 2C is a cross sectional view of the tire assembly on a rim with opposing sloping surfaces;

FIG. 3 is a cross sectional view of a tire assembly having a central disc constructed in accordance with an embodiment of the present invention;

FIG. 4A is a perspective view of a tire assembly having cavities in each tire;

FIG. 4B is a cross sectional view of the tire assembly of FIG. 4A; and

FIG. 5 is a perspective view of a tire assembly having four tires constructed in accordance with an embodiment of the present invention.

### DETAILED DESCRIPTION OF THE PRESENT INVENTION

The present invention relates to a tire assembly comprising a plurality of non-pneumatic tires removably disposed on a single rim. As used herein, the term “a single rim” refers to one rim that is disposed on an axle. As used herein, the term “rim” refers to a central disc that is disposed on an axle and, if present, an outer mounting ring on which a plurality of non-pneumatic tires may be removably disposed. As used herein, the term “non-pneumatic tire” includes the elastomer structure for contacting the ground and, if present, a band that is molded or adhered, with an adhesive or bonding agent, to the elastomer structure and removably disposed on the rim. An adhesive may also be used when the tire is molded to the band.

In one embodiment, the tire assembly comprises a plurality of modular or interchangeable non-pneumatic tires. Each of the plurality of non-pneumatic tires may be mounted to the outer circumference of a respective band, whereby the bands may provide additional structural support to the inner circumference of the non-pneumatic tire. Optionally, the bands provide an inner surface that sildeably engages the rim thereby removably disposing the non-pneumatic tires to a single rim. In one embodiment, each of the bands is removably mounted to a rim, e.g., a single rim, or central disc of the single rim. Preferably, one or more mounted bands are removably secured or mounted to a mounting ring that is part of the rim, which preferably includes a central disc.

Non-pneumatic tires made from a polyurethane elastomer may also be removably mounted to a single rim by heating the tire which allows the expanded tire to be placed onto a cold band. As the non-pneumatic tire cools, the tire shrinks onto the band to create an interference fit. In this embodiment, the tire may be mounted to the band with or without bonding agents. In another embodiment, the non-pneumatic tire is press fit onto the band, e.g., with the aid of a tire press, to create an interference fit between the tire and the band, which is preferably sufficient to prevent rotation of the tire relative to the band. In this embodiment, the tire may be mounted to the band with or without bonding agents.

In one embodiment, each of the non-pneumatic tires is interchangeable with another non-pneumatic tire, such that each non-pneumatic tire has a substantially similar shape and dimension. Of course, other embodiments of the present invention include tire assemblies comprised of non-pneumatic tires having varied characteristics, such as, but in no way limited to, tread pattern, non-pneumatic tire width, and materials comprising the non-pneumatic tire. See, for example, U.S. Pat. No. 4,832,098, U.S. Pat. No. 4,934,425, U.S. Pat. No. 4,921,029, U.S. Pat. No. 4,784,201, and U.S. Pat. No. 5,605,657, the entireties of which are incorporated herein by reference.

One advantage of having a tire assembly comprising a plurality of non-pneumatic tires that are removably disposed on a single rim is that such a tire assembly allows each non-pneumatic tire to be molded separately from the rim. In addition, a tire assembly having interchangeable non-pneumatic tires would allow selective replacement of a portion of the tire assembly, e.g., replacement of one or more damaged tires without replacing all of the tires, as opposed to replacing the entire tire assembly when one of the plurality of non-pneumatic tires is damaged. This allows, for example, a single rim to be re-used with multiple non-pneumatic tires. This also permits replacement non-pneumatic tires to be manufactured in bulk and then stored for later use as part of a tire assembly removably mounted to a rim that is in use on a vehicle, as needed. An additional advantage is that the generally narrower tires employed in the embodiments of the present invention are more easily handled than a wider tire.

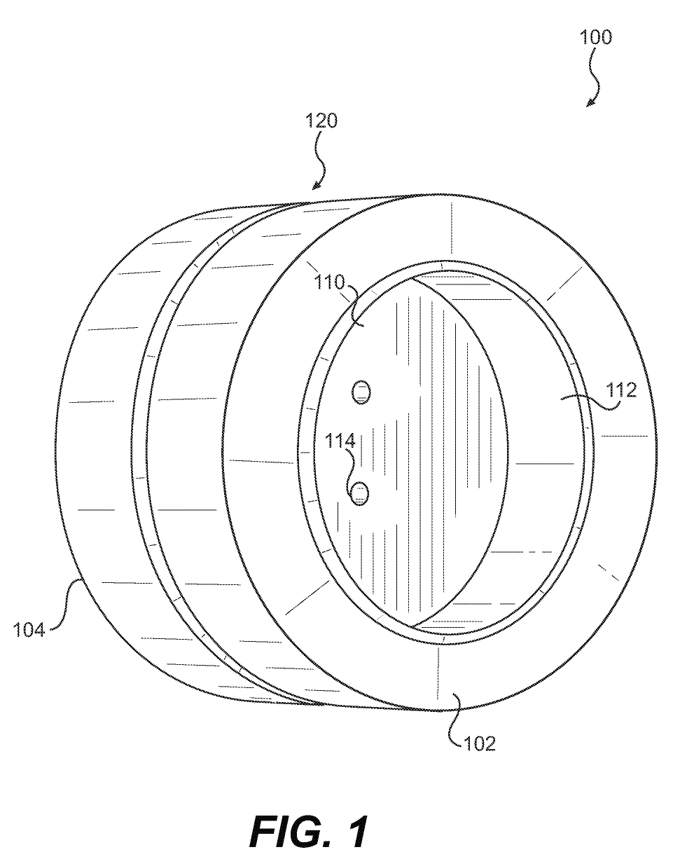

Referring to FIG. 1, there is illustrated an exemplary tire assembly 100 comprising two non-pneumatic tires 102 and 104, and rim 110 comprising a mounting ring 112 and openings 114 to mount on an axle hub (not shown). Tires 102 and 104 are shown in FIG. 1 as being disposed on mounting ring 112 of rim 110. In one embodiment, a gap 120 separates non-pneumatic tires 102 and 104. The gap may be formed, for example, by bands on which tires 102, 104 are mounted, in which case the width of one or more of the bands may be wider than the width of the respective tires. Additionally or alternatively, a separate spacer may be employed to laterally separate tires 102, 104. The spacer may, for example, be a ring that slips on rim 110 between the two tires 102, 104. The gap may range in size, for example, from greater than 0 inches (0 cm) to 18 (46 cm), e.g., 1 inch (3 cm) to 6 inches (15 cm) or 7 inches (18 cm) to 18 inches (46 cm). Optionally, the tires abut adjoining tires, i.e., no appreciable gap laterally separates the tires. Rim 110 is mounted to an axle hub (not shown) through openings 114.

Rim 110 may be constructed from metal, reinforced fiberglass plastics, metallic alloys, combinations thereof, or any other suitable material well known to those skilled in the art. In some exemplary preferred embodiments rim 110 is constructed of steel or aluminum.

In one embodiment, rim 110 lacks any lips or projections extending upwardly (i.e., radially) along the lateral edges of rim 110, such as those commonly employed when using pneumatic tires, to confine tires 102 and 104 to rim 110. Instead, non-pneumatic tires 102 and 104 are removably mounted and preferably slideably engage rim 110. Such a configuration provides the ability, for example, for non-pneumatic tires, e.g., interchangeable non-pneumatic tires, to either be added to rim 110 without having to mold or adhere such an interchangeable non-pneumatic tire directly to rim 110 or for an interchangeable non-pneumatic tire to be removed from rim 110 without damaging the tire or rim 110. Such a configuration also allows for the easy removal of damaged tires from rim 110, and replacement thereof.

Suitable materials for non-pneumatic tires 102 and 104 include, for example, elastomeric materials, such as those described in U.S. Pat. No. 4,832,098, U.S. Pat. No. 4,934,425, U.S. Pat. No. 4,921,029, U.S. Pat. No. 4,784,201, U.S. Pat. No. 5,605,657, and U.S. application Ser. No. 09/919,994, filed on Aug. 2, 2001, the entire contents and disclosure of which are hereby incorporated by reference. One exemplary material may be a polyurethane elastomer comprising a prepolymer formed from a diisocyanate and a polyol, e.g. polycaprolactone, polyester, poly(tetramethylene ether) glycol (PTMEG), etc., that is cured with diamine curative such as 4,4′-methylene-bis(2-chloroaniline) (MBCA); 4,4′-methylene-bis(3-chloro-2,6-diethylaniline (MCDEA); diethyl toluene diamine (DETDA; Ethacure™ 100 from Albemarle Corporation); tertiary butyl toluene diamine (TBTDA); dimethylthio-toluene diamine (Ethacure™ 300 from Albemarle Corporation); trimethylene glycol di-p-amino-benzoate (Vibracure™ A157 from Chemtura Company, Inc. or Versalink™740M from Air Products and Chemicals); methylene bis orthochloroaniline (MOCA), methylene bis diethylanaline (MDEA); methylenedianiline (MDA); and MDA-sodium chloride complex (Caytur™21 and 31 from Chemtura Company). Exemplary elastomeric materials suitable for non-pneumatic tires include polyurethanes such as those formed from commercially available Adiprene™ polyurethane prepolymers and Caytur™ diamine curatives from Chemtura Corp., a segmented copolyester such as Hytrel 5556 from DuPont, a reaction injection molded material, and a block copolymer of nylon such as Nyrim from Monsanto Chemical Co. In this disclosure, polyurethane elastomer refers to a polymer with urethane linkages (derived from an isocyanate group and a hydroxyl group) and optionally, urea linkages as well (derived from an isocyanate group and an amine group). Examples of such polyurethane elastomers are disclosed in U.S. Pat. Nos. 5,077,371, 5,703,193, and 6,723,771, and U.S. application Ser. No. 11/702,787, filed on Feb. 5, 2007, the entire contents and disclosure of which are hereby incorporated by reference. The tires of the present invention preferably are non-pneumatic, meaning that they are made of a solid material that does not require inflation to be operational. A significant benefit of non-pneumatic tires is that the non-pneumatic tires eliminate the risks associated with pneumatic tire failures, blowouts, and punctures. Further, a reduction in such risks also reduces the maintenance time and cost for an OTR vehicle using a tire assembly of the present invention.

An additional benefit of tire assembly 100 is that the use of multiple non-pneumatic tires may facilitate the ability of non-pneumatic tires 102 and 104 to dissipate heat. This is due to the increased surface area of non-pneumatic tires 102 and 104. A reduction in heat may also decrease the risk of a tire failure and advantageously increase tire lifetime.

Even in the event of a tire failure, tire assembly 100 preferably allows a vehicle to be driven on the remaining undamaged non-pneumatic tires of the tire assembly. Later, the vehicle may be moved to a maintenance facility using the non-damaged non-pneumatic tires of the tire assembly thereby eliminating the need for towing the vehicle to the maintenance facility. For example, in an embodiment where one non-pneumatic tire of a tire assembly having four non-pneumatic tires is damaged, the tire assembly may continue to function using the three remaining undamaged tires of the tire assembly. In addition, reduced material costs result because there is no need to replace the entire tire assembly as only the damaged non-pneumatic tire is replaced to restore the tire assembly to full capacity. Similarly, such tires are smaller in width than the rim and thus may be lighter than other non-pneumatic tires having the same width as the rim, which thereby reduces the storage and handling requirements.

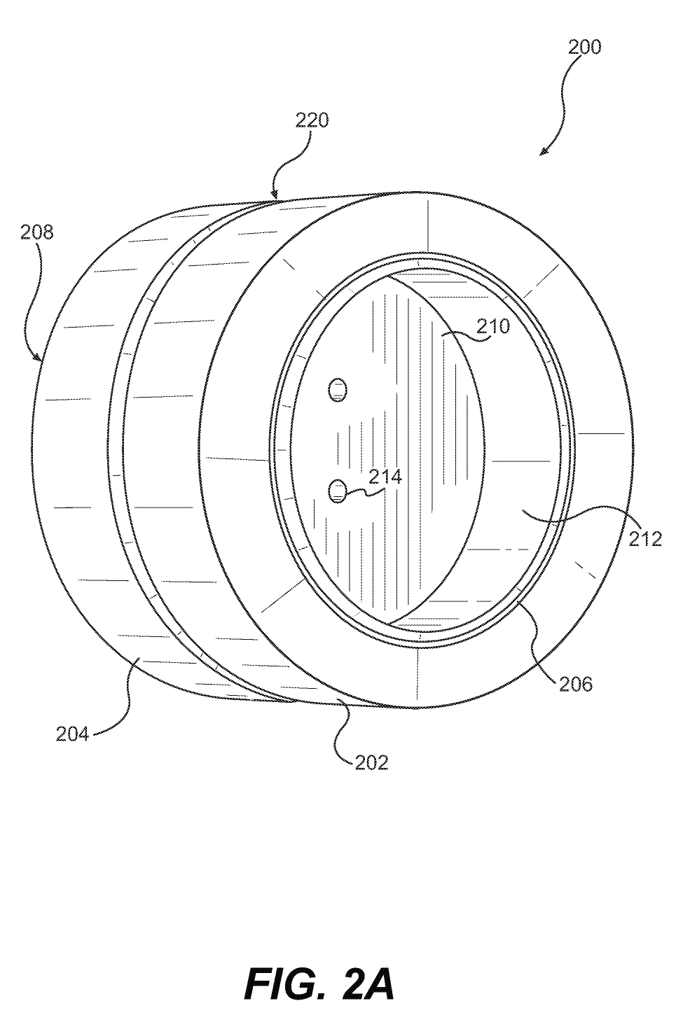

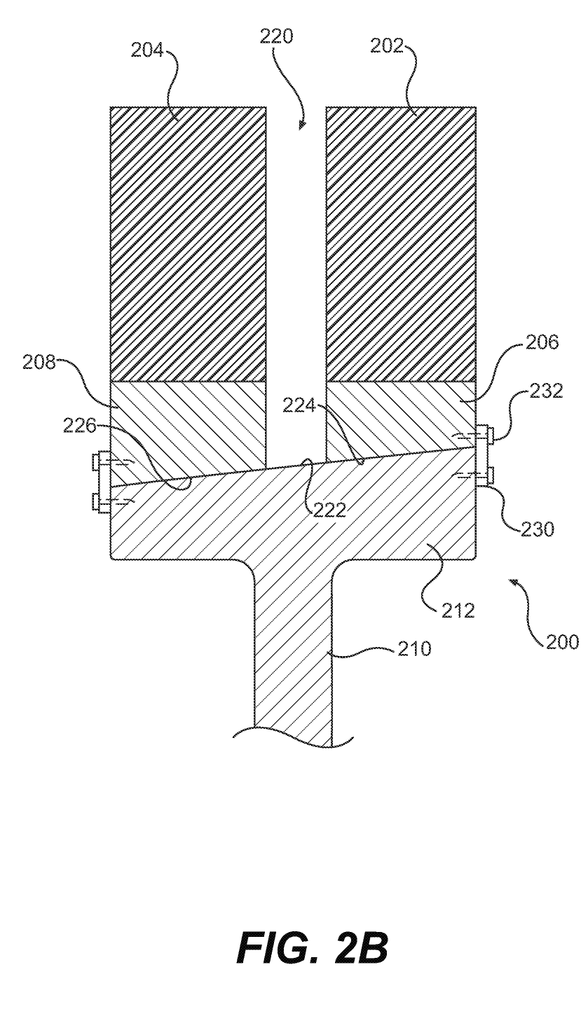

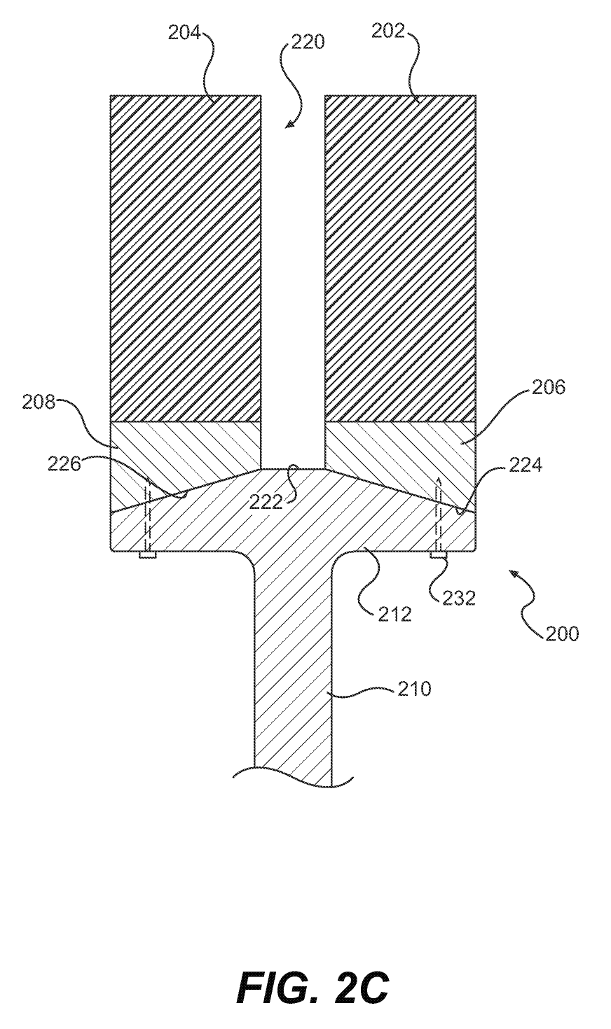

FIG. 2A illustrates a tire assembly 200, comprising non-pneumatic tires 202 and 204 mounted to bands 206 and 208 (on opposing side of tire assembly 200). Bands 206 and 208 are removably mounted to a mounting ring 212 of a single rim 210. Rim 210 also comprises openings 214 for mounting to an axle hub (not shown). A gap 220 may optionally separate tire 202 and tire 204. The gap may range, for example, from greater than 0 inches (0 cm) to 18 (46 cm), e.g., 1 inch (3 cm) to 6 inches (15 cm), or, e.g., 7 inches (18 cm) to 18 inches (46 cm). Optionally, the tires abut adjoining tires, i.e., no appreciable gap laterally separates the tires.

Bands 206 and 208 may be constructed from metal, reinforced fiberglass plastics, metallic alloys, combinations thereof, or any other suitable material well known to those skilled in the art. In one embodiment, bands 206 and 208 are constructed of steel or aluminum.

In one embodiment, non-pneumatic tires 202 and 204 are adhered directly to bands 206 and 208. In another embodiment, non-pneumatic tires 202 and 204 are affixed to bands 206 and 208 using an adhesive or bonding agent. In still another embodiment, non-pneumatic tires 202 and 204 are fitted to bands 206 and 208 using an interference fit. Of course, other embodiments may permit non-pneumatic tires to be removably mounted to the band. The bands 206 and 208 preferably add rigidity to each tire 202 and 204 and facilitate mounting and removal of each tires 202, 204 on or from rim 210.

In one embodiment, as shown in FIG. 2B, mounting ring 212 of rim 210 has a sloping outer surface 222 that engages a corresponding surface 224 and 226 of each respective band 206 and 208. The angle of sloping outer surface preferably is from 0° to 60°, e.g., from 5° to 30°, or from 5° to 15°. In one embodiment, band 206 and 208 may be mounted to the rim 210 as described in co-pending U.S. Ser. No. 12/______, entitled “TIRE RIM,” filed on Feb. 25, 2008 (attorney docket no. 2008P003.US), the entire contents and disclosure of which is hereby incorporated by reference. For example, surface 224 of band 206 slideably engages the outer surface 222 of mounting ring 212. Surface 226 of band 208 also slideably engages mounting ring 212 in the same direction, after mounting of the first tire 202. Surfaces 224 and 226 have a corresponding angle that slideably engages sloping outer surface 222. As shown in FIG. 2B, band 208 may be larger, i.e. has a greater radial height, than band 206 so that the treads of tires 202 and 204 are substantially parallel to level terrain. In embodiments of the present invention, any of the bands may be larger than the other bands provided that the treads of each tire removably mounted to the rim is substantially parallel to level terrain.

Optionally, as shown in FIG. 2C, mounting ring 212 of rim 210 has opposing sloping surfaces 222. The angle of sloping outer surface 222 preferably is from −60° to 60° relative to a lateral direction, e.g., from −30° to 30° or from −15° to 15°. In some embodiments, the angle of the sloping outer surface 222 may be different on each side. Bands 206 and 208 slideably engage mounting ring 212 in opposing directions along respective surfaces 224 and 226. Each surface 224 and 226 has a corresponding slope to engage one side of the opposing sloping surface 222. As shown in FIG. 2C, bands 206 and 208 have substantially the same size so that the treads of tires 202 and 204 are parallel to level terrain. In this embodiment, it may be necessary to remove rim 210 from the vehicle when replacing the inner tire that faces toward the vehicle. Of course, other embodiments may include tire assemblies combining aspects shown in FIGS. 2B and 2C, e.g., a rim having opposing sloping surfaces, as shown in FIG. 2C, each sloping surface having multiple bands removably attached thereto, as shown in FIG. 2B.

Of course, some means may be employed to removably secure each tire to the rim prior to operation so that the removably mounted tires do not separate from the rim during vehicle operation. In one embodiment of the present invention, each band may be secured to the rim using one or more fasteners, such as, for example, screws and bolts. In some aspects, such fasteners may be used to further secure the removably mounted band to the rim. As shown in FIG. 2B, for example, a plurality of plates 230 and fasteners 232 may be used to further secure bands 206 and 208 to rim 210. In another optional embodiment, shown in FIG. 2C, a fastener 232 may be inserted through a hole in the inner circumferential surface of the rim 210. It should be appreciated that the methods of fastening shown in FIG. 2B may be used in FIG. 2C, and vice versa. Other non-limiting methods of securing bands 206 and 208 to rim 210 include press-on, splines, keyways, other mechanical fasteners, or a slide on configuration with bolts. Of course, other suitable methods well known to those skilled in the art may be used to removably attach bands 206 and 208 to rim 210.

Although FIGS. 2B and 2C illustrate sloping surfaces that engage each band, in other embodiments, the mounting ring of the rim may have a substantially flat surface, i.e. substantially parallel to the lateral direction, to engage each band. In such embodiments, there may be provided one or more fasteners for securing each respective band to the mounting ring.

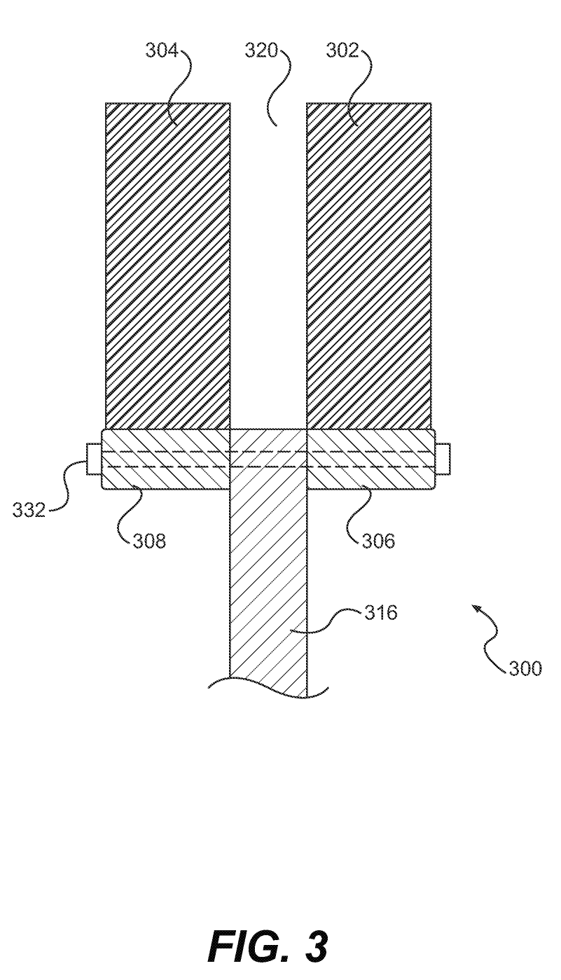

FIG. 3 shows an alternative embodiment to FIGS. 2A-2C, in which tire assembly 300 comprises non-pneumatic tires 302 and 304, bands 306 and 308, and a central disc 316. In this embodiment, a gap 320, substantially equal to the width of central disc 316, separates tires 302 and 304. Each band 306 and 308 is mounted to central disc 316 using a fastener 332, as shown. In this embodiment, the rim comprises a central disk 316, which, unlike the previous embodiments, does not include a circumferential mounting ring attached thereto. Optionally, each band 306 and 308 may overlap the edge of central disc 316 so as to reduce the gap between tires 302 and 304.

In another embodiment, not shown, each band includes a centrally-directed radial flange oriented about is inner circumference surface through which a plurality of fasteners are inserted to removably mount each tire to the central disc. In still another embodiment, not shown, each band may have one or more interlocking mechanisms that engages corresponding interlocking mechanisms, e.g. male/female connectors, interlocking teeth, etc., on central disc or a mounting ring attached to central disc.

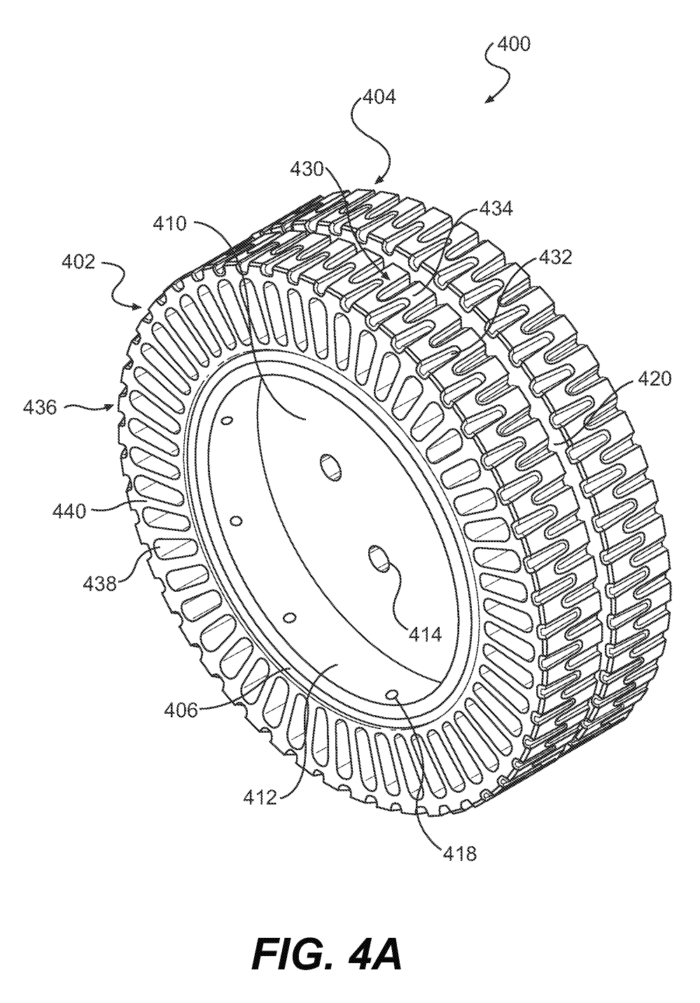

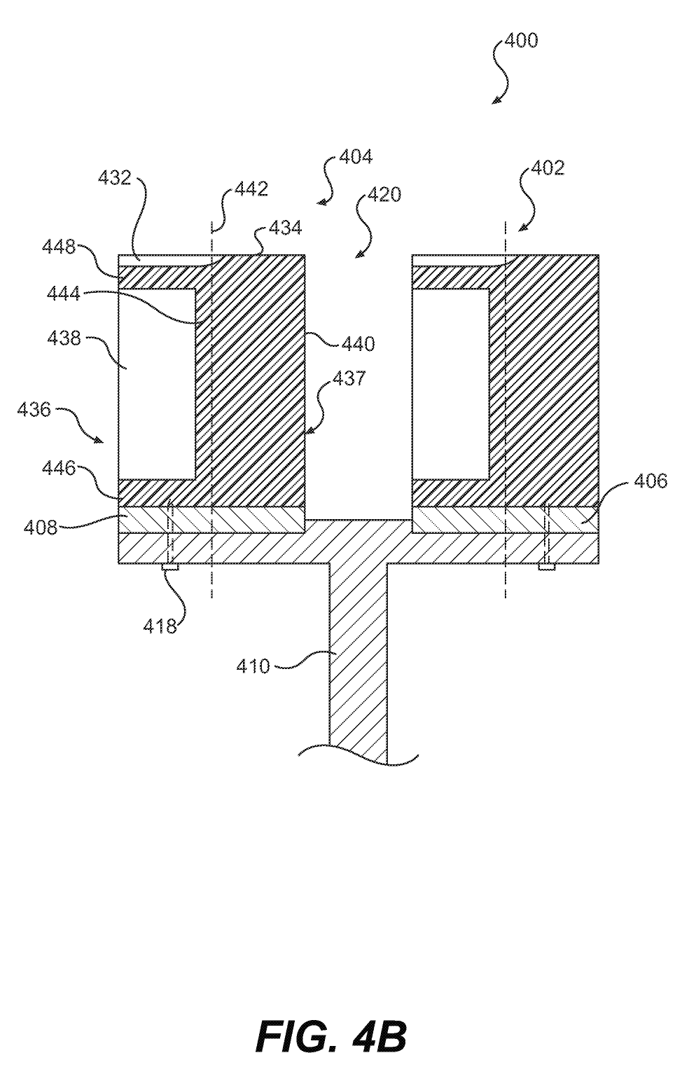

The non-pneumatic tires suitable for use with the present invention may have a variety of configurations as shown in U.S. Pat. No. 4,832,098, U.S. Pat. No. 4,934,425, U.S. Pat. No. 4,921,029, and U.S. Pat. No. 4,784,201, the entire contents and disclosures of which are hereby incorporated by reference. FIGS. 4A and 4B illustrate a tire assembly 400 having non-pneumatic tires 402 and 404, bands 406 and 408, and rim 410. Rim 410 comprising a mounting ring 412 and openings 414 to mount to an axle hub. As discussed above, in one embodiment tires 402 and 404 are adhered to bands 406 and 408. Bands 406 and 408 are each removably mounted to rim 410 using one or more fasteners 418. As shown in FIG. 4B, bands 406 and 408 slideably engage rim 410 within a depression in mounting ring 412, such that a gap 420 is provided between tires 402 and 404.

Each tire 402 and 404 optionally is similar to those described in co-pending U.S. Ser. No. 12/______, entitled “NON-PNEUMATIC TIRE,” filed on Feb. 25, 2008 (attorney docket no. 2008P005.US), the entire contents and disclosure of which is hereby incorporated by reference. That specification describes tires having cavities and tire tread grooves that are substantially aligned on the same sidewall and substantially offset with respect to the cavities and tire tread grooves on the other opposing sidewall. Other embodiments include tires having cavities and tread grooves that are substantially offset on the same sidewall and substantially offset with respect to the cavities but aligned with tread grooves on the opposing sidewall. Embodied tire assemblies 400 of the present invention are, e.g., suited for both types of non-pneumatic tires and will be described but not limited to the former embodiments. Each tire 402 and 404 comprises a tread pattern 430 having a plurality of tread grooves 432 and tread footprints 434. Tread footprint 434 is the portion of tire pattern 430 that is in contact with the ground or other similar surface. It should be readily understood that tire pattern 430 in this example is continuous around the outer circumference of each tire 402 and 404. Each tire 402 and 404 also comprises two sidewalls 436, 437 each having a plurality of cavities 438 separated by ribs 440. Cavities 438 extend from a plane perpendicular to sidewalls 436, 437 towards a centerline 442. Near centerline 442 is a web 444. Cavities 438 are separated from the respective bands 406 and 408 by inner circumferential member or hoop 446 and from tread pattern 430 by outer circumferential member or loop 448.

As shown, each tread groove 432 extends laterally across a portion of the width of each tire 402 and 404 and opens near the shoulder region where tread pattern 430 adjoins each sidewall 436, 437. In one configuration, tread grooves 432 are substantially offset relative to the ribs 440, but are in substantial radial alignment with cavities 438 that are on the same sidewall 436 thereof. Tread grooves 432 alternate along tread pattern 430 as shown in FIG. 4A. As shown in this embodiment, tread grooves 432 extend in from the shoulder of tire 402 and 404 without bending or angling relative to the lateral direction as shown in FIG. 4A.

As shown in FIG. 4A, cavities 438 and ribs 440 extend radially from a center axis of each tire 402 and 404. As used herein, the terms radially and radial refer to being in line with a direction that extends perpendicularly from the center axis of each tire 402 and 404. Radial cavities 438 have a substantially oval or trapezoidal shape with the distance between ribs 440 closest to rim 410 being less than the distance between the same ribs 440 closest to tread pattern 430, although other geometries may be employed.

In one embodiment as shown in FIG. 4B, each cavity 438 is defined by the inner circumferential member or hoop 446, outer circumferential member or hoop 448 and adjacent ribs 440. Staggered cavities 438 extend inwardly perpendicular to a plane of sidewall 436 with substantially straight walls such that the open area of cavity 438 is approximately equal to the area of the cavity on web 444. In other embodiments, the walls of cavity 438 may be angled or sloped inwardly in which case the area of cavity 438 on web 444 is less than the opening area of cavity 438.

As shown, the staggered cavities 438 on both sidewalls 436, 437 extend into each tire 402 and 404 towards central web 444. On sidewall 437, cavities 438 are staggered or offset relative to cavities 438 on the other side of central web 444, such that ribs 440 on sidewall 436 align with cavities 438 on opposing sidewall 437. Such staggering of cavities 438 reduces the amount of material used in the mold when making each tire 402 and 404 while maintaining desirable strength, durability and lifetime characteristics for the tire. The configuration of cavities 438, ribs 440, and grooves 432 act together to strengthen web 444. The configuration also significantly reduces the weight of each tire 402 and 404.

In the embodiment of FIGS. 4A and 4B, cavities 438 and tread grooves 432 are radially aligned relative to each other and create a pattern as follows. On one sidewall 436, ribs 440 are in substantial radial alignment with corresponding footprints 434, while on the opposing sidewall 437 a cavity 438 is in substantial radial alignment with tread groove 432. This alternating pattern between tread pattern 430 and sidewalls 436, 437 repeats for the entire circumference of each tire 402 and 404. In other aspects, not shown, the cavities and/or ribs may not be radially oriented, but instead are angled relative to the radial direction. In this aspect, load carrying ability is sacrificed for improved radial flexibility. Such embodiments may be well-suited, for example for traveling on rugged terrain.

The number of cavities 438, ribs 440 and grooves 432 may vary depending on the configuration of each tire 402 and 404. Each tire 402 and 404 may have from 10 to 80 cavities, or more preferably from 25 to 60 cavities on each sidewall. Each tire 402 and 404 may have from 10 to 80 ribs, or more preferably from 25 to 60 ribs on each sidewall. Each tire 402 and 404 may have from 0 to 320 grooves, or more preferably from 40 to 120 grooves in the tire pattern. Embodiments with zero grooves may be referred to as slick tires, which lack a tread pattern. In one embodiment, each tire 402 and 404 has the same number of cavities, ribs and grooves. In another embodiment tire 402 has a configuration of cavities, ribs and grooves that is different from tire 404. In such embodiments, the overall shape and dimension of tire 402 is substantially similar to tire 404. Thus tire 404 has the same overall shape and dimension of tire 402 but with a different configuration. It should be understood that the tires of FIGS. 1-3 may have a tire configuration similar to FIGS. 4A and 4B.

In another embodiment, one of the tires has a radial rib configuration as shown in FIGS. 1A-1C of U.S. Ser. No. 12/______, entitled “NON-PNEUMATIC TIRE,” filed on Feb. 25, 2008 (attorney docket no. 2008P005.US), previously incorporated by reference above. The other tire may have an angled rib configuration as shown in FIGS. 2A-2B of co-pending U.S. Ser. No. 12/______, entitled “NON-PNEUMATIC TIRE,” filed on Feb. 25, 2008 (attorney docket no. 2008P005.US). Additional embodiments may have each tire selected from a group consisting of solid tires, tires having radial ribs and tires having angled ribs. In one embodiment, when the same configuration, i.e. ribs that are offset from grooves, is selected for each tire, the number of cavities, ribs and grooves for each tire may be different. Also, in one embodiment, when both tires have either radial or angled ribs, one tire may have cavities that are aligned on each sidewall with the ribs, while the other tire has cavities that are offset from the ribs on each sidewall.

The dimensions of non-pneumatic tires used with embodiments of the present invention may be affected by various design parameters such as ground pressure (traction), vertical spring rate (ride), cornering power (handling), total deflection, material volume, and tire weight. For example, tire 100 has an outer diameter that may range from 25 inches (64 cm) to 190 inches (483 cm), e.g. from 60 inches (152 cm) to 159 inches (404 cm) or from 63 inches (160 cm) to 100 inches (254 cm). An inner diameter that may range from 20 inches (51 cm) to 140 inches (356 cm), e.g. from 30 inches (76 cm) to 110 inches (279 cm) or from 40 inches (102 cm) to 80 inches (203 cm). A tread width that may range from 7 inches (18 cm) to 35 inches (89 cm), e.g. from 10 inches (25 cm) to 30 inches (76 cm) or from 12 inches (30 cm) to 25 inches (64 cm). The rim to which each tire is mounted may range from 15 inches (38 cm) to 70 inches (178 cm), e.g. from 20 inches (51 cm) to 59 inches (150 cm) or from 26 inches (66 cm) to 29 inches (74 cm). The height of sidewall may range from 2 inches (5 cm) to 110 inches (279 cm), e.g. from 5 inches (13 cm) to 80 inches (203 cm) or from 15 inches (38 cm) to 50 inches (127 cm). Each cavity may have a depth ranging from 5 inches (13 cm) to 20 inches (51 cm), e.g. from 8 inches (20 cm) to 15 inches (38 cm) or from 10 inches (25 cm) to 13 inches (33 cm). Each rib may have a thickness ranging from 2 inches (5 cm) to 15 inches (38 cm), e.g. from 5 inches (13 cm) to 13 inches (33 cm) or from 8 inches (20 cm) to 11 inches (28 cm). Web may have a thickness ranging from 4 inches (10 cm) to 14 inches (36 cm), e.g. from 4.5 inches (11 cm) to 12 inches (30 cm) or from 5 inches (13 cm) to 10 inches (25 cm). Grooves may have a depth from 0.25 inches (1.0 cm) to 12 inches (30 cm), e.g. from 2 inches (5 cm) to 8 inches (20 cm) or from 2.5 inches (6 cm) to 8 inches (15 cm), and a lateral length of less than 30 inches (76 cm), e.g. less than 18 inches (46 cm) or less than 15 inches (38 cm).

The tire assembly of the present invention may support 20,000 to 200,000 lbs per tire (9,000 kg to 91,000 kg per tire), e.g. 40,000 to 150,000 lbs per tire (18,000 kg to 68,000 kg per tire) or 60,000 to 100,000 lbs per tire (27,200 kg to 45,400 kg per tire). In one embodiment, a tire assembly of the present invention may support such weighs when the vehicle is traveling of speeds in the range from 0 to 60 mph (0 to 97 km/hr), e.g. 5 to 40 mph (8 to 64 km/hr) or 20 to 30 mph (32 to 48 km/hr). Each of the tires may weigh approximately 500 lbs (227 kg) to 15,000 lbs (6,804 kg), e.g., 2,000 lbs (907 kg) to 10,000 lbs (4,535 kg) or 6,000 lbs (2721 kg) to 8,000 lbs (3,629 kg).

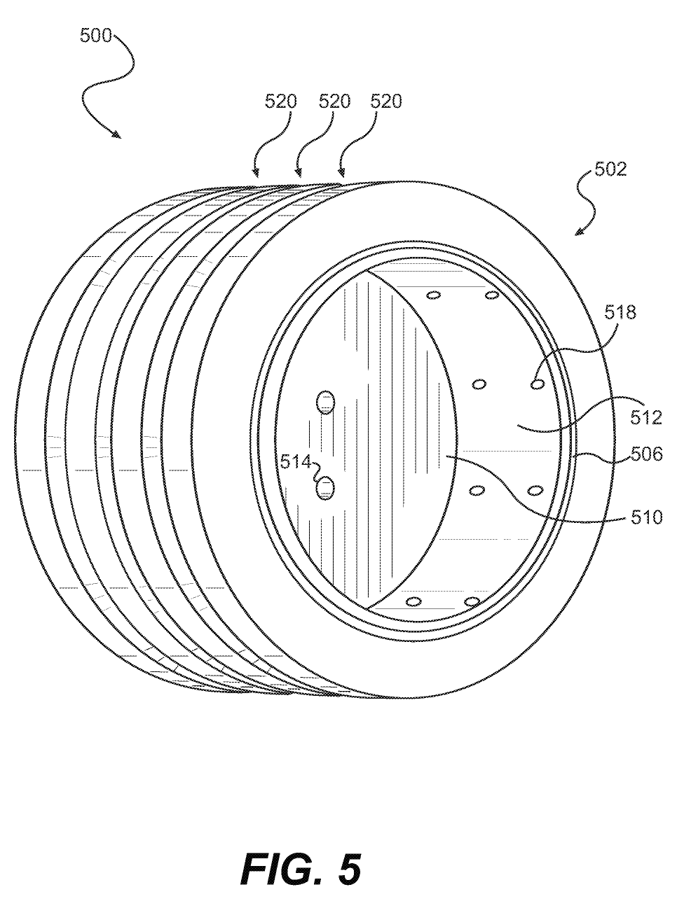

Although FIGS. 1-4 show tire assemblies having two non-pneumatic tires, additional non-pneumatic tires (e.g., 3, 4, 5, 6, 7, 8 or more tires) may be used with other embodiments of the present invention. As shown in FIG. 5, tire assembly 500 comprises four non-pneumatic tires 502 removably mounted on a mounting ring 512 of a single rim 510. A gap 520 may separate each of the tires 502. Each of the non-pneumatic tires 502 may have an interference fit with mounting ring 512, and optionally one or more of the non-pneumatic tires 502 may be mounted to a band 506 that is secured to mounting ring 512 using a fastener 518. Optionally, one or more of the non-pneumatic tires 502 may have other suitable fasteners as shown in FIGS. 2B, 2C, 3 or 4B to secure such tires 502 to the mounting ring 512. In other embodiments, there may be, for example, between 2 and 10 tires 502 removably mounted to a single rim 510. Rim 510 has openings 514 for mounting rim 510 to an axle hub (not shown). Such embodiments allow tire assemblies 500 to be expanded with additional tires 502. For example, a tire assembly having two non-pneumatic tires may be replaced with four tires having a collective radial width substantially equal to the combined radial width of the two replaced non-pneumatic tires.

Tire assemblies according to the invention may be well-suited for off-the-road (OTR) vehicles and capable of providing a better ride for OTR vehicles. In some embodiments, each of the rims of an OTR vehicle has a tire assembly of the present invention. In other embodiments, less than all of the rims, such as 1, 2, 3, 4, or 5 rims, of an OTR vehicle have a tire assembly of the present invention. As indicated above, non-pneumatic tires made of elastomeric materials are well-suited for this invention.

Tire assemblies of the present invention may be repaired, e.g., using the following process. First, any securing means, e.g., screws, bolts, etc., are removed and the damaged non-pneumatic tire is removed, preferably slideably removed, from the rim. If the damaged tire is an interior tire, it may be necessary to first remove one or more undamaged tires in order to obtain access to the damaged tire. In a preferred aspect, the tires are molded or adhered to respective bands, and the band attached to the damaged non-pneumatic tire is slideably removed from the rim with the tire still attached thereto. Next, a replacement tire having the desired shape and dimension is removably mounted to the rim. In one embodiment, the desired shape and dimension is similar to that of the removed non-pneumatic tire. In another embodiment, the desired shape and dimension may differ from that of the removed non-pneumatic tire to better meet the circumstances under which the tire assembly will be used. Alternatively, a band having a replacement tire having the desired shape and dimension is removably mounted to the rim. Of course, if the damaged tire is an interior tire, after the damaged tire is replaced the other undamaged tires may be removably mounted to the rim to complete the tire assembly. Once assembled, the replacement tire and existing tire collectively comprise a tire assembly removably disposed on a single rim. In one embodiment, each of the non-pneumatic tires on the single rim is removed and replaced by two or more replacement non-pneumatic tires.

In another embodiment, this process further comprises affixing the replacement non-pneumatic tire to a band and then disposing the replacement non-pneumatic tire on the rim to form the tire assembly. The replacement non-pneumatic tire may optionally be molded or adhered to the band. It should be understood that the processes described above may occur without removing the entire tire assembly from the vehicle, e.g., OTR vehicle.

Tire assemblies of the present invention having two tires may be formed, e.g., using the following process. Each of the non-pneumatic tires is adhered to a band. In an alternative embodiment, the tires are molded to the band and secured using an adhesive. Next, the bands are removably mounted to a single rim. In one embodiment the bands are secured to the rim using one or more fasteners. The process of forming the tire assemblies, e.g., affixing the non-pneumatic tires to respective bands; and removably mounting the non-pneumatic tires and corresponding bands to a rim, may be done at different locations. For example, in one embodiment, the tires are molded and adhered to the bands at a manufacturing facility and shipped to a maintenance facility. The maintenance facility assembles the tire assemblies by mounting the bands to a single rim.

While this invention has been described with reference to illustrative embodiments and examples, the descriptions above are not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

### EXAMPLE

A tire assembly comprising two tires adhered to a single rim is provided. Each tire has an outer diameter of approximately 74 inches (188 cm), a width of approximately 15 inches (38 cm), and disposed on a rim having an outer diameter of approximately 47 inches (120 cm) and an overall width of approximately 30 inches (76 cm). The ribs and tread grooves are offset. Each tire abuts the adjoining tire and there is substantially no gap. Such a tire assembly supports approximately 39,700 lbs per tire (18,000 kg per tire) up to speeds of approximately 30 mph (47 km/hr). Each tire weighs approximately 1900 lbs (862 kg).

What is claimed is:

1. A tire assembly comprising a plurality of non-pneumatic tires removably disposed on a single rim.

2. The tire assembly of claim 1, wherein each of the plurality of non-pneumatic tires are made of a polyurethane elastomer.

3. The tire assembly of claim 1, each of the plurality of non-pneumatic tires is mounted to a respective one of a plurality of bands.

4. The tire assembly of claim 3, wherein each of the plurality of bands are removably mounted to the rim.

5. The tire assembly of claim 1, wherein each of the plurality of non-pneumatic tires comprise:
a first sidewall having a plurality of first sidewall cavities; and
a second sidewall having a plurality of second sidewall cavities, wherein the plurality of first sidewall cavities are substantially staggered with respect to the plurality of second sidewall cavities.

6. The tire assembly of claim 5, further comprising:
a plurality of tread grooves, wherein each of the plurality of tread grooves is substantially aligned with one of the plurality of first sidewall cavities or the plurality of second sidewall cavities on the first sidewall or second sidewall from which each of the plurality of tread grooves extends.

7. The tire assembly of claim 5, further comprising a slick tread pattern.

8. The tire assembly of claim 1, wherein each of the plurality of non-pneumatic tires are a solid tire having no cavities or ribs.

9. The tire assembly of claim 1, wherein one or more gaps laterally separate each of the plurality of non-pneumatic tires from one another.

10. The tire assembly of claim 1, wherein each of the plurality of non-pneumatic tires has a substantially similar shape and dimension.

11. The tire assembly of claim 1, wherein the plurality of non-pneumatic tires and rim form an interference fit.

12. An off-the-road vehicle comprising the tire assembly of claim 1.

13. A tire assembly comprising:
a central disc;
a plurality of bands removably mounted to the single central disc; and
a plurality of non-pneumatic tires, each of the plurality of non-pneumatic tires being mounted to a respective one of the plurality of bands.

14. The tire assembly of claim 13, wherein each of the plurality of non-pneumatic tires are made of a polyurethane elastomer.

15. The tire assembly of claim 13, wherein each of the plurality of non-pneumatic tires are molded onto a respective one of the plurality of bands.

16. The tire assembly of claim 13, wherein each of the plurality of non-pneumatic tires are affixed to a respective one of the plurality of bands with an adhesive.

17. The tire assembly of claim 13, wherein each of the plurality of non-pneumatic tires comprise:
a first sidewall having a plurality of first sidewall cavities; and
a second sidewall having a plurality of second sidewall cavities, wherein the plurality of first sidewall cavities are substantially staggered with respect to the plurality of second sidewall cavities.

18. The tire assembly of claim 17, further comprising:
a plurality of tread grooves, wherein each of the plurality of tread grooves is substantially aligned with one of the plurality of first sidewall cavities or the plurality of second sidewall cavities on the first sidewall or second sidewall from which each of the plurality of tread grooves extends.

19. The tire assembly of claim 13, further comprising one or more gaps, wherein each of the one or more gaps separate each of the plurality of non-pneumatic tires.

20. The tire assembly of claim 13, wherein each of the plurality of non-pneumatic tires has a substantially similar shape and dimension.

21. An off-the-road vehicle comprising the tire assembly of claim 13.

22. A process for repairing a tire assembly comprising:
(a) removing at least one of a plurality of non-pneumatic tires disposed on a single rim; and
(b) replacing the at least one of a plurality of removed non-pneumatic tires with at least one replacement non-pneumatic tire on the rim.

23. The process of claim 22, wherein at least one replacement non-pneumatic tire has a substantially similar shape and dimension as the removed non-pneumatic tire.

24. The process of claim 22, wherein the at least one replacement non-pneumatic tire is affixed to a band, which is removably mounted to the single rim.

25. The process of claim 22, wherein step b) is performed while each of the remaining plurality of non-pneumatic tires remain disposed on the single rim.

26. A process for forming a tire assembly, comprising:
removably mounting a first non-pneumatic tire to a rim; and
removably mounting a second non-pneumatic tire to the rim.

27. The process of claim 26, further comprising removably mounting a third non-pneumatic tire to a rim.

28. The process of claim 26, wherein the first and second non-pneumatic tires are affixed to a first and second band, respectively, and wherein the first and second bands are removably mounted to the rim.

29. The process of claim 28, wherein the first non-pneumatic tire is molded to the first band.

30. The process of claim 28, wherein the second non-pneumatic tire is molded to the second band.

31. The process of claim 28, wherein the first non-pneumatic tire is adhered to the first band using an adhesive.

32. The process of claim 28, wherein the second non-pneumatic tire is adhered to the second band using an adhesive.

33. The process of claim 28, further comprising:
mounting a third non-pneumatic tire to a third band; and
removably mounting the third band to the single rim.
